(19) United States
(12) Patent Application Publication
(10) Pub. No.: US 2004/0236679 A1
(43) Pub. Date: Nov. 25, 2004

(54) Method and system for performing automated prepaid account renewal

(76) Inventor: David J. Anderson, Lawrenceville, GA (US)

Correspondence Address: CANTOR COLBURN LLP, 55 GRIFFIN ROAD SOUTH, BLOOMFIELD, CT, 06002, US

(21) Appl. No.: 10/441,810

(22) Filed: May 20, 2003

(51) Int. Cl. G06F 17/60

(52) U.S. Cl. 705/39

(57) ABSTRACT

A method for performing automated prepaid account renewal comprising receiving notification that a customer is due for a renewal inquiry telephone call and initiating a telephone call to the customer using an auto-dialing device. Notification is received at a voice platform that the customer has answered the telephone call. The voice platform includes a text-to-speech device, a speech recognition device and a language model. A verbal message is transmitted, via the text-to-speech device, to the customer offering to perform a renewal process for the customer. In response to the transmitting, a message is received from the customer via the speech recognition device. A renewal process is performed in response to the message including a request to initiate the renewal process, where the renewal process is responsive to communication between the voice platform and the customer. The telephone call is transferred to a call center in response to the message including a request to transfer the telephone call to the call center. A call-back process is performed in response to the message including a request to initiate the call-back process, where the call-back process is responsive to the communication between the voice platform and the customer.

### BACKGROUND OF THE INVENTION

The present disclosure relates generally to a method for performing automated prepaid account renewal and in particular, to a method for utilizing an interactive speech application positioned on a voice platform to automatically contact a customer by telephone about scheduling or renewing an order for a service or a product.

Computer-based interactive speech applications are widely used in telephone systems to answer incoming calls as well as to perform various tasks including gathering information from callers, providing information to callers, and connecting callers with appropriate parties. Typically, the call flow is activated when the system receives an incoming call, and begins with a system-generated greeting followed by a list of available options. The application waits for a response from the caller and processes the response when received. The application must be able to recognize what the caller said in order to determine what should happen next. The application performs this determination by converting the caller's speech into a text sentence of distinct words (speech recognition); breaking down the recognized sentence grammatically and then systematically representing its meaning (natural language understanding); obtaining targeted data based on that meaning's representation from an appropriate online source (information retrieval); building a text sentence that presents the retrieved data in the user's preferred language (language generation); and converting that text sentence into computer-generated speech (speech synthesis or text-to-speech conversion).

As interactive speech application technology continually improves, applications for utilizing speech recognition for information retrieval systems are becoming a more popular resource for consumers. As an example, “Info-by-Voice for Atlanta” was an automated, voice-operated telephone portal that was available to consumers in the metropolitan area surrounding Atlanta, Georgia who wished to obtain directory assistance information concerning topics such as restaurants, traffic information, stock quotes, weather, sports and business news. By using this service, a caller provided information in response to a series of questions from a pre-recorded voice, and then received a list of names and contact information for businesses matching the desired criteria. For example, if a caller submitted a request for Chinese restaurants, the system might identify five places for the caller to consider. In this manner, an audio information retrieval directory can provide a useful and convenient resource for local and topical information.

Similarly, the current process for subscribers to renew airtime minutes for wireless telephone service includes connecting to an automated service. The current process requires the subscriber to track their remaining time period (e.g. for a thirty or forty-five day period) and their remaining airtime. The subscriber can call an automated service or check remaining time via the service menu on the telephone. If the service period for a subscriber expires, the remaining airtime for the subscriber is usually lost shortly thereafter. The subscriber must then visit a store to purchase an additional airtime card or call an automated service to renew the period or the airtime. If the subscriber purchased an airtime card, the subscriber must call an automated service to report a PIN for the card in order to activate the related airtime. The automated service is typically reached by dialing an abbreviated telephone number (e.g., 611) or a toll free number. If needed, customer service can assist in the renewal process. Note too, if the service period or airtime runs out, the subscriber must then call the toll free number from a landline telephone and provide additional information about the wireless telephone for the refill process. This current process is not convenient for the subscriber nor does it proactively promote increased wireless usage.

### BRIEF DESCRIPTION OF THE INVENTION

One aspect of the present invention is a method for performing automated prepaid account renewal. The method comprises receiving notification that a customer is due for a renewal inquiry telephone call and initiating a telephone call to the customer using an auto-dialing device. Notification is received at a voice platform that the customer has answered the telephone call. The voice platform includes a text-to-speech device, a speech recognition device and a language model. A verbal message is transmitted, via the text-to-speech device, to the customer offering to perform a renewal process for the customer. In response to the transmitting, a message is received from the customer via the speech recognition device. A renewal process is performed in response to the message including a request to initiate the renewal process, where the renewal process is responsive to communication between the voice platform and the customer. The telephone call is transferred to a call center in response to the message including a request to transfer the telephone call to the call center. A call-back process is performed in response to the message including a request to initiate the call-back process, where the call-back process is responsive to the communication between the voice platform and the customer.

In another aspect, a computer program product for performing automated prepaid account renewal comprises a storage medium readable by a processing circuit and storing instructions for execution by the processing circuit for performing a method. The method comprises receiving notification that a customer is due for a renewal inquiry telephone call and initiating a telephone call to the customer using an auto-dialing device. Notification is received at a voice platform that the customer has answered the telephone call. The voice platform includes a text-to-speech device, a speech recognition device and a language model. A verbal message is transmitted, via the text-to-speech device, to the customer offering to perform a renewal process for the customer. In response to the transmitting, a message is received from the customer via the speech recognition device. A renewal process is performed in response to the message including a request to initiate the renewal process, where the renewal process is responsive to communication between the voice platform and the customer. The telephone call is transferred to a call center in response to the message including a request to transfer the telephone call to the call center. A call-back process is performed in response to the message including a request to initiate the call-back process, where the call-back process is responsive to the communication between the voice platform and the customer.

In a further aspect, a system for performing automated prepaid account renewal comprises a network, a call center in communication with the network, and a voice platform in communications with the network. The voice platform includes an auto-dialing device, a speech recognition device, and a text-to-speech device and instructions to implement a method. The method comprises receiving notification via the network that a customer is due for a renewal inquiry telephone call and initiating a telephone call via the network to the customer using an auto-dialing device. Notification is received via the network at the voice platform that the customer has answered the telephone call. A verbal message is transmitted, via the network and the text-to-speech device, to the customer offering to perform a renewal process for the customer. In response to the transmitting, a message is received from the customer via the network and the speech recognition device. A renewal process is performed in response to the message including a request to initiate the renewal process, where the renewal process is responsive to communication between the voice platform and the customer. The telephone call is transferred via the network to the call center in response to the message including a request to transfer the telephone call to the call center. A call-back process is performed in response to the message including a request to initiate the call-back process, where the call-back process is responsive to the communication between the voice platform and the customer.

### BRIEF DESCRIPTION OF THE DRAWINGS

Referring to the exemplary drawings wherein like elements are numbered alike in the several FIGURES:

FIG. 1 is a block diagram of an exemplary system for performing automated prepaid account renewal;

FIG. 2 is a block diagram of a process flow for performing automated prepaid account renewal;

FIG. 3 is a database layout of an exemplary customer account information database for performing automated prepaid account renewal; and

FIG. 4 is a block diagram of an exemplary scripting and language model for performing automated prepaid account renewal and call back offers.

### DETAILED DESCRIPTION OF THE INVENTION

An exemplary embodiment of the present invention includes auto-dialing equipment empowered with a speech-enabled, voice platform. The voice platform includes a voice application to deliver a conversational dialog to the subscriber through a ‘free’ call to their wireless or landline telephone. The voice application greets and engages the called party, inviting their participation in the renewal or refill transaction. The speech technology, involving speech recognition and natural language understanding methods, permits a controlled, dynamic conversation with the called party to determine their interest and then carries out the necessary transaction(s). Throughout the voice application service call, the subscriber may interrupt with their response that may be ‘close’ (but not necessarily exact) to the suggested responses in the service's prompt.

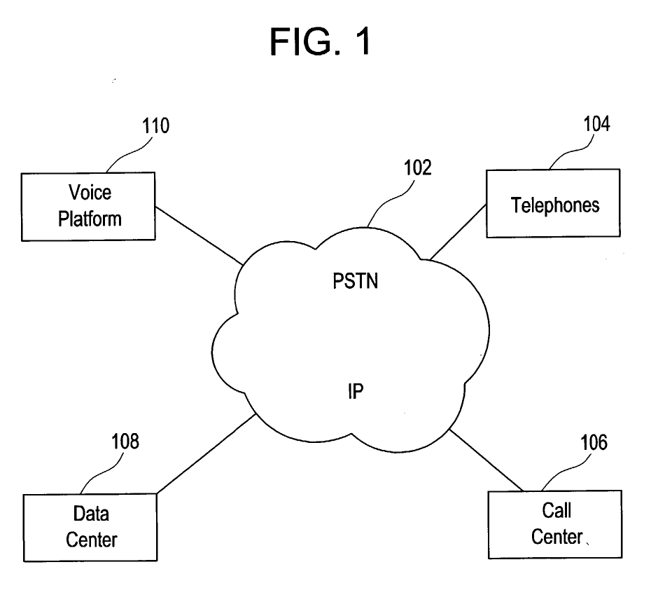

FIG. 1 is a block diagram of an exemplary system for performing automated prepaid account renewal. The exemplary system includes a voice platform 110, a data center 108, telephones 104, and a call center 106 all connected to a network 102. Telephone calls to customers located at the telephones 104 are generated by out-dialing/auto-dialing equipment included in the voice platform 110. Data relevant to each telephone call is retrieved as needed from one or more databases located on the voice platform 110 and/or at the data center 108. At any time during the conversation (e.g., called party requests, response from called party is not understood) the called party may be connected to the appropriate call center 106 for follow-up with a customer service representative. This connection to a call center 106 may be performed by bridging at the voice platform or through redirection in the network 102.

The network 102 may be any type of known network including, but not limited to, a public switched telephone network (PSTN), a wide area network (WAN), a local area network (LAN), a global network (e.g. Internet), a virtual private network (VPN), a voice over Internet protocol (VOIP) and an intranet. The network 102 may be implemented using a wireless network or any kind of physical network implementation known in the art. One or more of the voice platform 110, the telephones 104, the data center 108 and the call center 106 may be connected to the network 102 in a wireless fashion. In addition, one or more of the voice platform 110, the data center 108 and the call center 106 may be physically located in the same geographic location or they may be at three different geographic locations as depicted in FIG. 1. In an exemplary embodiment of the present invention a PSTN is utilized to provide communication between the voice platform 110, the telephones 104 and the call center 106; and the Internet is utilized to provide communication between the voice platform 110, the data center 108 and the call center 106.

The voice platform 110 is the foundation on which the automated prepaid account renewal application is developed and deployed. It executes the commands and logic specified by the voice application, provides the speech processing capabilities (e.g., speech recognition, text-to-speech), interfaces to databases at the data center 108, interfaces to the call center 106 and provides system management. Any voice platform 110 known in the art may be utilized in an exemplary embodiment of the present invention (e.g.,Tellme Studio from Tellme Networks, Inc. and Freespeech from HeyAnita, Inc.). In an exemplary embodiment of the present invention, speech recognition and voice recognition are provided by a purchased software package (e.g., Nuance Version 8.0 by Nuance Communications, Inc. and OpenSpeech Recognizer from SpeechWorks International, Inc.). Similarly, text-to-speech capability may be provided by a purchased product (e.g., Speechify from SpeechWorks International, Inc.). The voice platform 110 includes access to a customer database of current subscribers as well as a language model and application logic to control the flow of the conversation. The components of the voice platform 110 may be located at the same geographic location as depicted in FIG. 1 or they may be located in different geographic locations and communicate via the network 102.

At least two approaches, known in the art, may be utilized to predict the set of responses expected from the potential customer. One approach is to use a deterministic directed language model that involves having a person, or a team of people, looking at the application and related data elements, predicting responses to all phrases and writing out all expected responses. These expected responses along with data in the customer database are utilized to create a language model. Another approach is a statistical language model approach where responses to questions from a live service representative are collected during a large number of calls and processed through a voice analysis tool to create a language model and related meaning. Any voice analysis tool (e.g., as provided by Nuance Communications, Inc. or SpeechWorks International Inc. for Call Routing.) known in the art may be utilized with an embodiment of the present invention. This process of data collection and language model tuning may be performed on a periodic basis to keep the respective language models up-to-date. The language model is stored on a storage device located on the voice platform 110 or at the data center 108.

The telephones 104 depicted in FIG. 1 include conventional landline telephones and wireless mobile phones. The telephones 104 are located in a variety of geographic locations (e.g., homes, cars, offices) and are in communication with the voice platform 110 via the network 102. Also depicted in FIG. 1 is a call center 106 for sales or service. In an exemplary embodiment, the call center 106 includes customer service representatives (e.g., account renewal specialists) that are ready to talk to existing subscribers via telephone when a telephone call is routed to the call center 106 from the voice platform 110. FIG. 1 also includes a data center 108 in communication with the network. The data center 108 may include a storage device containing application databases and legacy computer systems that provide input to the voice platform 110 application. For example, an event occurring in a computer system (e.g., a customer capacity is less than a pre-specified amount) at the data center 108 may trigger a telephone call to be initiated by the voice platform 110. A storage device may also be included in the voice platform 110. The storage devices located at one or both of the voice platform 110 and the data center 108 may be implemented using a variety of devices for storing electronic information. It is understood that the storage devices may be implemented using memory contained in a host system located at the data center 108 or at the voice platform 110 or they may be separate physical devices. The storage devices are logically addressable as a consolidated data source across a distributed environment that includes a network 102. The physical data may be located in a variety of geographic locations depending on application and access requirements. Information stored in the storage devices may be retrieved and manipulated via the voice platform 110 or via a host system located at the data center 108. The storage devices include the scripting, the language models and the customer database.

An alternate embodiment of an exemplary system for performing automated prepaid account renewal includes one or more multimodal devices in communication with the voice platform 110 via the network 102. Multimodal devices may be utilized to apply the most appropriate medium for the task at hand (e.g., voice, visual data). For example, for applications performed primarily by a user in motion, speech may be the best medium to use to communicate with the user. Alternatively, if a user requests a listing of all restaurants serving a particular type of food and in a particular city or location, a visual list of all restaurants fitting the category may be presented to the user. If the list only includes one or two restaurants, the list may be relayed verbally to the user. In addition, account renewal calls may be received by a multimodal device with visual content that complements the voiced scripting. The visual content may include a visual display of options, features and/or packages for the service or a product. In another scenario, a visual reminder message is left pertaining to the renewal of services or products. A variety of multimodal scenarios may be implemented with an exemplary embodiment of the present invention and the scenarios will vary based on user requirements for particular applications.

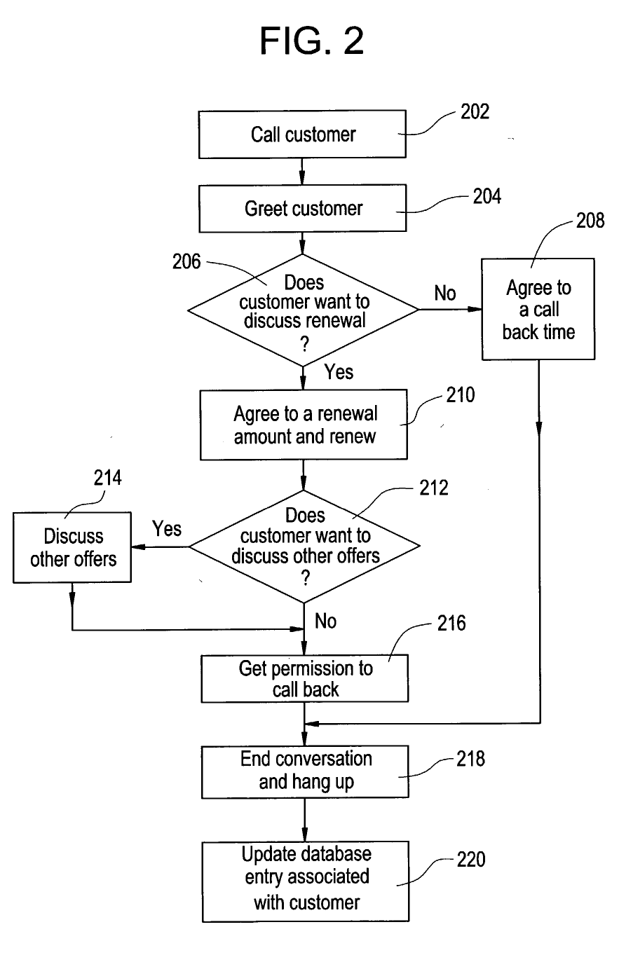

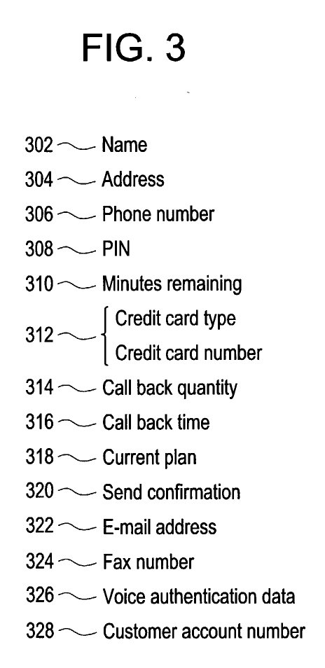

FIG. 2 is a block diagram of a process flow for performing automated prepaid account renewal. At step 202, a customer is called. In an exemplary embodiment of the present invention, the customer being called is a current subscriber located in a customer database. The customer may be a subscriber to a service that may or may not be monitored (e.g., car maintenance, propane fuel at a restaurant, wireless telephone minutes) or to a service that provides a product on a regular or as needed basis (e.g., fishing license renewal, hospital supplies, paper supplies). The customer is being called because it is a particular day that has been scheduled for a telephone reminder call or because the customer's supplies or services are or are expected to be running low. Information about the scheduled call or supplies running low may be included in a customer database as depicted in FIG. 3 and described below. At step 204, the voice application greets the customer and at step 206 the voice application determines if the customer wants to discuss renewal, re-supply or scheduling. In an exemplary embodiment of the present invention, the voice application transmits a greeting within a pre-specified time period of receiving a notification that the customer has answered the telephone. If this pre-specified time period is relatively short (e.g., one second) customer hang-ups may be avoided. If the timing is bad for the customer, step 208 is performed and the voice application may offer to call again and can set a more convenient time for the customer, regardless of the time, the phone number or the day of week. Processing then continues with step 218.

If it is determined, at step 206, that the customer wants to discuss a renewal, then step 210 is executed to perform the renewal process. The renewal process includes conversing with the customer to determine the amount of the service or product that the customer would like to receive. In addition, it includes pulling information from an entry in a customer database corresponding to the customer to assist in the transaction. If a previous credit card is not on record for the customer, a prompt for a credit card number and expiration date may be executed and then verified with a clearance center for acceptance. If no credit card is available, directions to the nearest, open retail outlet may be provided to handle a cash transaction. A transfer to a customer service representative is also possible, as needed or requested, at any time during the telephone call. Confirmation of the transaction is provided during the telephone call and a hard copy receipt may be mailed, faxed or emailed as requested by the customer.

If appropriate for the business, additional services may be offered in a cross promotional offer. Next, step 212 is performed to determine if the customer would like to discuss other promotional offers. If the customer does want to discuss other promotions, then step 214 is performed. At step 214 the voice application tells the customer about other promotional offers and in response to the customer ordering one of the offers, the voice application processes the order. Processing continues at step 216.

Otherwise, if the customer does not want to discuss other promotional offers, step 216 is performed. At step 216, the voice application, in an exemplary embodiment of the present invention, makes an attempt to obtain permission from the customer to call again when the customer's airtime reaches a customer-specified confirmed level (e.g., ten remaining minutes for a sixty minute refill, fifteen remaining minutes for a one-hundred and twenty minute refill). Alternatively, the voice application may make an attempt to obtain permission to call back a customer at a customer-specified time interval. Next, step 218 is performed and the voice application ends the conversation with a closing script from the language model and then hangs up the telephone.

At step 220, the customer database entry associated with the customer is updated based on the activities that occurred during the telephone conversation (e.g., a call-back time is updated, the minutes remaining field is updated). In an exemplary embodiment of the present invention, the entry in the customer database corresponding to the customer is updated with the new amount of service or product, the type of purchase plan, and the amount paid. If user authentication is required, for example to perform product renewal, a prompt for a previously established personal identification number (PIN), pass code or voiceprint (with voice verification technology) may be executed. In addition, at any point in time, the telephone call may be transferred to the call center 106. The transfer may occur because of customer request or it may occur because the voice application does not understand the response from the customer. In either case, the call and call history are passed to the call center 106.

An example application that may be performed utilizing an exemplary embodiment of the present invention is presented below. The example application is for renewing airtime minutes for a wireless service. An example of a conversation, or dialog, that may take place between the voice application, or service, and the customer is as follows.

Called Party: Hello.

Service: Hi Mr. Jones, I'm VAL from XYZ. This is the reminder you requested to renew your airtime. Can we do this now?

Called Party: Not right now.

Service: Shall I call back later this (afternoon or evening or tomorrow morning)? (based on the time this call takes place)

Called Party: Call me tomorrow afternoon around 4.

Service: Excellent. I'll call you then.

Next Day at 4:05 pm

Called Party: Hello.

Service: Hello Mr. Jones, this is VAL. I'm calling back to renew your airtime. Is it convenient now?

Called Party: Yes.

Service: Great. You have 5 minutes remaining on your plan. Shall I renew your account for another 90 minutes?

Called Party: Yeah, sure.

Service: That will be 90 minutes at our special renewal rate of $0.20/minute for a total of $18. Is this OK?

Called Party: Yes, it's OK.

Service: Ok. Are you interested in adding Long Distance to anywhere in the US? I can tell you more about this plan.

Called Party: No, just more minutes.

Service: I understand. Shall I charge your 90-minute refill to the Visa Credit card you used before . . . or is there a different card you'd like to use?

Called Party: The same card.

Service: Ok, I'll charge this renewal to your Visa Card and email (mail, FAX) you a receipt (to your home).

NOTE to reader: Automatic voice verification can occur successfully during this dialog exchange if the subscriber previously enrolled, otherwise, a specific prompt requesting the subscriber's PIN pass code can be requested to verify the called party's previously established identity.

Service: Shall I call you in the future when your airtime again reaches 10 minutes?

Called Party: Yes.

Service: I'll call you then. Thank you for your business. Good-bye.

FIG. 3 is a database layout of an exemplary customer database for performing automated prepaid account renewal as described in the above dialog. The exemplary customer database record includes: a name attribute 302 for storing the customer name, an address attribute 304 for storing the customer address; a phone number attribute 306 for storing one or more telephone numbers associated with the customer; a PIN attribute 308 for use in verifying the identity of the customer; a minutes remaining attribute 310 for tracking how much time remains on the customer account; a credit card attribute 312 including both a credit card number and a credit card type; a call back quantity attribute 314 for specifying a quantity that will trigger a renewal telephone call; a call back time attribute 316 for specifying a date and time that will trigger a renewal telephone call to the customer; and a current plan attribute 318 for describing the current customer plan, this may be utilized in determining special promotions to offer to the customer. The exemplary customer database record also includes: a send confirmation attribute 320 to trigger the sending of a confirmation and to specify the manner of confirmation (e.g., fax, electronic-mail); an e-mail address attribute 322; a fax number attribute 324; a voice authentication data attribute 326 for use with voice verification technology; and a customer account number attribute 328 for accessing information about the customer account. Other customer database layouts may be utilized with an exemplary embodiment of the present invention. The customer database will be tailored based on the specific voice application being implemented.

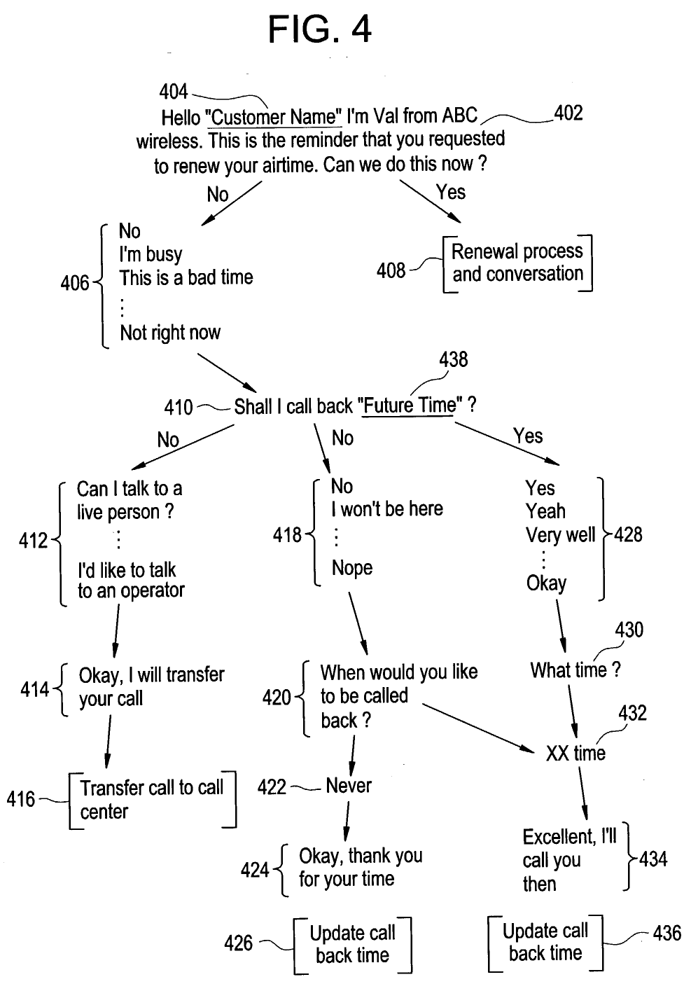

FIG. 4 is a block diagram of exemplary scripting and related language models for performing automated prepaid account renewal as described in the above dialog. The scripting may include a tree layout as depicted in FIG. 4 to navigate through the possible responses and language models. Other layouts (e.g., object oriented, relational) are possible with the particular layout being tailored to the specific voice application being implemented. The “greeting” script 402 includes the words that are spoken by the voice application when it has been determined that the customer has answered the telephone. It includes a customer name entry 404 that, in this exemplary embodiment, will be sourced from the name attribute 302 in the customer database. Depending on the response from the customer to the “greeting script” 402, either the “renewal process script” 408 will be initiated or the “callback script” 410 will be initiated. The “callback script” 410 is initiated if the “customer greeting response” 406 is a word or phrase to indicate that the customer does not want to renew at this time. The “callback script” 410 includes a future time entry 438 that will be determined by the voice application based on factors including the current time. Responses to the “callback script” 410 include a “call center transfer request” 412. When a customer requests a transfer to the call center 106, the voice application responds with a “call center transfer script” 414 and then transfers the call 416.

Another response to the “callback script” 410 includes a “select another time response” 418 in which case the voice application responds with a “please specify a time script” 420. The customer may respond with a “never call me back response” 422 in which case the voice application reads the “thank you for your time script” 424, ends the call and updates the customer database call back time attribute 316 with data to indicate not to call the customer back. Alternatively, the customer may respond to the “please specify a time script” 420 with a “time response” 432. In this case the voice application responds with a “”I'll call you back at that time script” 434 and updates the callback time attribute 316 in the customer database with the specified time.

Another response to the “callback script” 410 may include a “call me back at that time response” 428. When the “call me back at that time response” 428 is received, the voice application responds with the “what time script” 430. When the customer responds with a “time response” 432 processing proceeds as discussed previously. This example depicts a portion of the script for carrying out the dialog described previously. In an exemplary embodiment of the present invention all paths, including all anticipated responses, would be included in an inclusive set of language models. The contents of the language model are specific to the application being implemented. At any time during the dialog, if the voice application does not understand the customer response the call may be transferred to a call center 106 to be handled by a customer service representative.

In addition to the wireless telephone minute renewal example described previously, an embodiment of the present invention may be applied to any capacity based service where the subscriber's capacity can be monitored and an invited, personalized notification from the supplier can trigger the re-supply. This may include applications such as re-supplying gasoline and diesel fuel at a gas station. In addition, an exemplary embodiment of the present invention may be applied to any periodic re-supply or service call based on average usage. Periodic re-supply may include supplies at a doctor's office, propane for cooking or CO₂ for a drink station at a restaurant. An exemplary embodiment of the present invention may also be applied to any annual or cyclical re-occurring service transaction (e.g., renewal of a driver's license, fishing license, or club membership).

This automated, proactive notification and related transaction may be utilized as a stand-alone application or integrated with other existing applications to provide a business with: a convenient service that frees subscribers from tracking service periods or airtime; a proactive service that frees the subscriber from having to call the existing automated service or visit a retail store; an efficient way to motivate refills “just in time”; a low cost, retail store independent, market channel to the customer; and a competitive edge relative to competitors.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for performing automated prepaid account renewal, said method comprising:
receiving notification that a customer is due for a renewal inquiry telephone call;
initiating a telephone call to said customer using an auto-dialing device;
receiving notification at a voice platform that said customer has answered said telephone call, wherein said voice platform includes a text-to-speech device, a speech recognition device and a language model;
transmitting a verbal message via said text-to-speech device to said customer offering to perform a renewal process for said customer;
receiving a message from said customer via said speech recognition device in response to said transmitting;
performing a renewal process in response to said message including a request to initiate said renewal process, wherein said renewal process is responsive to communication between said voice platform and said customer;
transferring said telephone call to a call center in response to said message including a request to transfer said telephone call to said call center; and
performing a call-back process in response to said message including a request to initiate said call-back process, wherein said call-back process is responsive to said communication between said voice platform and said customer.

2. The method of claim 1 wherein said performing said renewal process includes:
determining a renewal quantity and a renewal price;
receiving payment from said customer, wherein said payment includes said renewal price;
updating a record for said customer to include said renewal quantity in response to said receiving payment; and
confirming the completion of said updating.

3. The method of claim 2 wherein said performing said renewal process further includes:
transmitting a verbal message to said customer via said text-to-speech device regarding a promotional offer.

4. The method of claim 2 wherein said receiving payment includes:
receiving a credit card number and expiration date for said customer; and
transmitting a request to a credit card company or credit card service to apply said renewal price to said credit card.

5. The method of claim 4 wherein said receiving payment further includes:
receiving a notice from said credit card company or credit card service that that said renewal price has been applied to said credit card.

6. The method of claim 2 wherein said receiving payment further includes authenticating the identity of said customer.

7. The method of claim 2 wherein said confirming the completion of said updating includes:
transmitting a verbal confirmation message via said text-to-speech device to said customer.

8. The method of claim 2 wherein said confirming the completion of said updating includes:
transmitting an electronic-mail receipt to said customer.

9. The method of claim 2 wherein said confirming the completion of said updating includes:
transmitting a facsimile receipt to said customer.

10. The method of claim 2 wherein said confirming the completion of said updating includes:
mailing a paper receipt to said customer.

11. The method of claim 1 wherein said performing a call-back process includes:
determining the criteria for when said customer is due for another said renewal inquiry telephone call; and
updating a record for said customer to include said criteria.

12. The method of claim 11 wherein said criteria includes a current quantity.

13. The method of claim 11 wherein said criteria includes an estimated current quantity.

14. The method of claim 11 wherein said criteria includes a periodic date.

15. The method of claim 11 wherein said criteria includes a specific date and time.

16. The method of claim 11 wherein said criteria includes instructions not to call said customer.

17. The method of claim 11 wherein said receiving a notification that said customer is due for said renewal inquiry telephone call is in response to said criteria in said record being met.

18. The method of claim 1 wherein said renewal inquiry relates to a product, wherein the quantity of said product held by said customer may be monitored.

19. The method of claim 18 wherein said product includes airtime minutes for a wireless telephone service.

20. The method of claim 18 wherein said product includes fuel at a gas station.

21. The method of claim 1 wherein said renewal inquiry relates to a product, wherein a pre-selected quantity of said product is ordered by said customer on a periodic basis.

22. The method of claim 1 wherein said communication between said voice platform and said customer is multi-lingual and a language is chosen based on the language spoken by said customer.

23. The method of claim 1 wherein said transmitting a verbal message occurs within a pre-specified time of said receiving notification.

24. The method of claim 1 wherein said pre-specified time is less than one second.

25. The method of claim 1 further comprising transmitting visual data to said customer.

26. The method of claim 25 wherein said visual data includes at least one of display options, features and packaging for a product or service.

27. A computer program product for performing automated prepaid account renewal, the computer program product comprising:
a storage medium readable by a processing circuit and storing instructions for execution by the processing circuit for performing a method comprising:
receiving notification that a customer is due for a renewal inquiry telephone call;
initiating a telephone call to said customer using an auto-dialing device;
receiving notification at a voice platform that said customer has answered said telephone call, wherein said voice platform includes a text-to-speech device, a speech recognition device and a language model;
transmitting a verbal message via said text-to-speech device to said customer offering to perform a renewal process for said customer;
receiving a message from said customer via said speech recognition device in response to said transmitting;
performing said renewal process in response to said message including a request to initiate said renewal process, wherein said renewal process is responsive to communication between said voice platform and said customer and to said language model;
transferring said telephone call to a call center in response to said message including a request to transfer said telephone call to said call center; and
performing a call-back process in response to said message including a request to initiate said call-back process, wherein said call-back process is responsive to said communication between said voice platform and said customer and to said language model.

28. A system for performing automated prepaid account renewal, the system comprising:
a network;
a call center in communications with said network; and
a voice platform including an auto-dialing device, a speech recognition device, and a text-to-speech device in communication with said network, said voice platform including instructions to implement the method comprising:
receiving notification via said network that a customer is due for a renewal inquiry telephone call;
initiating a telephone call via said network to said customer using an auto-dialing device;
receiving notification via said network at said voice platform that said customer has answered said telephone call;
transmitting a verbal message via said network and said text-to-speech device to said customer offering to perform a renewal process for said customer;
receiving a message from said customer via said network and said speech recognition device in response to said transmitting;
performing said renewal process in response to said message including a request to initiate said renewal process, wherein said renewal process is responsive to communication between said voice platform and said customer;
transferring said telephone call via said network to said call center in response to said message including a request to transfer said telephone call to said call center; and
performing a call-back process in response to said message including a request to initiate said call-back process, wherein said call-back process is responsive to said communication between said voice platform and said customer.

29. The system of claim 28 wherein said network is a public switched telephone network.

30. The system of claim 28 wherein said network is the Internet.

31. The system of claim 28 wherein said network includes a public switched telephone network and the Internet.

32. The system of claim 28 wherein said network includes a voice over Internet protocol.
